(19) United States
(12) Patent Application Publication
(10) Pub. No.: US 2026/0367481 A1
(43) Pub. Date: Nov. 19, 2026

(54) VARIABLE APERTURE DEVICE AND CAMERA MODULE

(71) Applicant: AAC Microtech (Changzhou) Co., Ltd., Changzhou City (CN)

(72) Inventors: Zhiwei Zhong, Changzhou (CN); Xin Jin, Changzhou (CN); Wei Song, Changzhou (CN)

(21) Appl. No.: 19/322,670

(22) Filed: Sep. 8, 2025

Related U.S. Application Data
(63) Continuation of application No. PCT/CN2025/094894, filed on May 14, 2025.

(51) Int. Cl. G03B 9/06

(52) U.S. Cl. CPC G03B 9/06

(57) ABSTRACT

Disclosed are a variable aperture device and a camera module. The device includes a housing, a stator, a rotor assembly, three blades, an elastic member, and guide members. The housing has an accommodation chamber, the stator is secured to the housing and positioned within the accommodation chamber, the rotor assembly is rotatably connected to the housing and positioned within the accommodation chamber, the blades are rotatably connected to the housing and connected to the rotor assembly, the elastic member has two ends connected to the housing and the rotor assembly, respectively, and the guide members are disposed between the housing and the rotor assembly and spaced apart in a circumferential direction of the variable aperture device, where the plurality of guide members are in point contact or surface contact with the rotor assembly.

### CROSS REFERENCE TO RELATED APPLICATIONS

The present disclosure is a continuation of PCT Patent Application No. PCT/CN2025/094894, filed May 14, 2025, which is incorporated by reference herein in its entirety.

### TECHNICAL FIELD

The present disclosure relates to the technical field of cameras, and in particular, to a variable aperture device and a camera module.

### BACKGROUND

A camera module is an important component of a smart device, and user experience of the camera module significantly affects an overall user experience of the smart device. Due to a limited installation space for the camera module in an electronic device such as a mobile phone, a fixed aperture device with a simple structure is typically employed. However, the fixed aperture device with a fixed aperture area fails to adapt to different shooting scenarios, and thus fails to meet diverse shooting needs of users. Therefore, with the development of the market, there is an increasing demand for a mobile phone equipped with a variable aperture device for imaging to satisfy various shooting requirements. For example, when performing telephoto shooting, a large aperture is used to enhance light intake and bokeh effect, whereas when performing close-focus shooting, switching to a small aperture improves resolution capability for close-range photography.

In the related art, a rotor in a variable aperture structure rotates relative to a stator, such that blades are driven to move and a size of a light-passing hole defined by a plurality of blades is changed, thereby adjusting an aperture size. However, during rotation of the rotor, the rotor is prone to being displaced relative to an optical axis, which causes the blades to become eccentric with respect to the optical axis, thereby affecting imaging quality.

Therefore, it is necessary to provide a novel variable aperture device to address the technical problems in the related art.

### SUMMARY

The present disclosure is intended to provide a variable aperture device and a camera module, which are capable of solving the technical problem that concentricity between a rotor and a stator in a variable aperture structure in the related art is prone to an offset.

The present disclosure adopts technical solutions described below.

In one aspect, embodiments of the present disclosure provide a variable aperture device. The variable aperture device includes a housing, a stator, a rotor assembly, at least three blades, an elastic member, and a plurality of guide members. The housing has an accommodation chamber. The stator is secured to the housing and positioned within the accommodation chamber. The rotor assembly is rotatably connected to the housing and positioned within the accommodation chamber. The at least three blades are rotatably connected to the housing and connected to the rotor assembly. The rotor assembly and the stator are mutually inductive to generate a drive force for driving the rotor assembly to rotate, and the at least three blades are configured to be driven by the rotor assembly to rotate relative to the housing, so as to form a light-passing hole with a variable aperture size. The elastic member has two ends connected to the housing and the rotor assembly, respectively. A plurality of guide members are disposed between the housing and the rotor assembly and spaced apart in a circumferential direction of the variable aperture device. The plurality of guide members are in point contact or surface contact with the rotor assembly.

In some embodiments, the rotor assembly includes a turntable rotatably disposed within the housing and connected to the at least three blades, where the plurality of guide members are positioned between an outer periphery of the turntable and an inner periphery of the housing and are in point contact or surface contact with the turntable.

In some embodiments, the housing includes a bottom plate, a first side plate, and a top plate. The first side plate extends from the bottom plate along an axial direction of the light-passing hole. The top plate is secured to an end of the first side plate away from the bottom plate. The bottom plate, the first side plate, and the top plate define the accommodation chamber. The turntable includes an annular base frame, and a guide portion. The annular base frame is rotatably connected to the first side plate. The guide portion extends from the base frame along the axial direction of the light-passing hole, where the first side plate and the guide portion are spaced apart from and face each other, and a respective guide member is disposed on an inner side of the first side plate and is in point contact or surface contact with the guide portion.

In some embodiments, the first side plate is provided with a positioning groove on a side of the first side plate facing the guide portion, and the respective guide member is assembled in the positioning groove.

In some embodiments, the first side plate is provided with a positioning portion on the side of the first side plate facing the guide portion, where the positioning portion protrudes toward the guide portion and is spaced apart from the guide portion, and the positioning groove is disposed in the positioning portion and extends through an end of the positioning portion adjacent to the base frame.

In some embodiments, the rotor assembly further includes a rotor unit secured to the turntable and sleeved on an outer side of the stator. A plurality of rotor units, a plurality of rotors and a plurality of elastic members are provided. The plurality of rotor units are spaced apart in the circumferential direction of the variable aperture device, and are disposed in one-to-one correspondence with the plurality of stators, and the plurality of elastic members are connected to the plurality of rotor units in one-to-one correspondence.

In some embodiments, a length direction of each respective elastic member of the plurality of elastic members extends in the circumferential direction of the variable aperture device, and two ends of the respective elastic member in the length direction are respectively connected to the housing and a respective rotor unit of the plurality of rotor units.

In some embodiments, the variable aperture device further includes a first conductive member and a second conductive member. The first conductive member is secured to the housing. The second conductive member is secured to the rotor assembly and spaced apart from the first conductive member. The elastic member is electrically connected to the first conductive member, the second conductive member, and the rotor assembly separately.

In some embodiments, the elastic member includes a connection portion, a first conductive portion and a second conductive portion. The connection portion is secured to the rotor assembly. The first conductive portion has two ends connected to the connection portion and the first conductive member, respectively. The second conductive portion has two ends connected to the connection portion and the second conductive member, respectively. The first conductive portion and the second conductive portion are spaced apart from each other.

In a second aspect, embodiments of the present disclosure provide a camera module. The camera module includes the variable aperture device as described above.

The beneficial effects of the present disclosure are as follows.

Under the action of a drive force generated by mutual induction between the rotor assembly and the stator, the rotor assembly rotates to drive the blades to rotate relative to the housing in a first direction. Under the action of a restoration force provided by an elastic member, the rotor assembly rotates to drive the blades to rotate relative to the housing in a second direction. The first direction and the second direction are opposite to each other, so that an aperture size of the light-passing hole is changed to achieve the adjustment of the aperture size. Moreover, since the guide member are disposed between the housing and the rotor assembly and are in point or surface contact with the rotor assembly, during rotation of the rotor assembly, the guide members can laterally support the rotor assembly and guide the rotation. This ensures coaxiality between the rotor assembly and the stator and suppresses eccentricity of the blades relative to an optical axis of the variable aperture device, thereby ensuring imaging quality.

### BRIEF DESCRIPTION OF THE DRAWINGS

FIG. 1 is a schematic structural view of a variable aperture device according to some embodiments of the present disclosure.

FIG. 2 is a schematic exploded structural view of a variable aperture device according to some embodiments of the present disclosure.

FIG. 3 is a schematic view illustrating assembly of a turntable, rotor units, and stators according to some embodiments of the present disclosure.

FIG. 4 is a schematic view illustrating assembly of a housing and a guide member according to some embodiments of the present disclosure.

FIG. 5 is a schematic view illustrating assembly of a first conductive member, a second conductive member, and an elastic member according to some embodiments of the present disclosure.

FIG. 6 is a schematic structural view of an elastic member according to some embodiments of the present disclosure.

### DETAILED DESCRIPTION

The present disclosure is further described with reference to the attached drawings and specific embodiments.

The present disclosure provides a camera module. The camera module includes a variable aperture device, which is capable of adjusting an amount of light intake of the camera module.

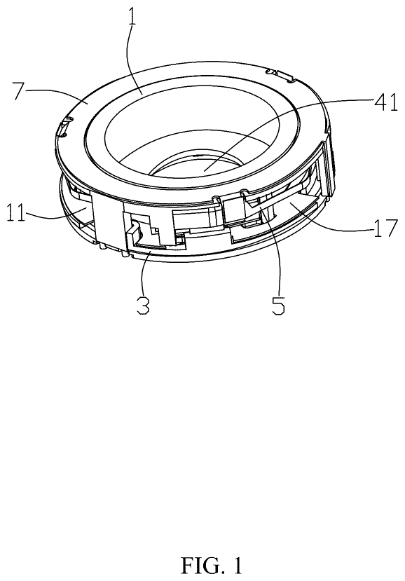

Referring to FIG. 1 to FIG. 6, the variable aperture device includes: a housing 1 having an accommodation chamber 11, a stator 2 secured to the housing 1 and positioned within the accommodation chamber 11, a rotor assembly 3 rotatably connected to the housing 1 and positioned within the accommodation chamber 11, and a plurality of blades 4 rotatably connected to the housing 1 and connected to the rotor assembly 3. The rotor assembly 3 and the stator 2 are mutually inductive to generate a drive force for driving the rotor assembly to rotate, and at least three blades 4 are provided. The at least three blades 4 are configured to be driven by the rotor assembly to rotate relative to the housing 1 so as to form a light-passing hole 41 with a variable aperture size. The variable aperture device further includes an elastic member 5 having two ends connected to the housing 1 and the rotor assembly 3, respectively, and a plurality of guide members 6 disposed between the housing 1 and the rotor assembly 3 and spaced apart in a circumferential direction of the variable aperture device. The plurality of guide members 6 are in point contact or surface contact with the rotor assembly 3.

Under the action of the drive force generated by mutual induction between the rotor assembly 3 and the stator 2, the rotor assembly 3 rotates to drive the blades 4 to rotate relative to the housing 1 in a first direction. Under the action of a restoration force provided by the elastic member 5, the rotor assembly 3 rotates to drive the blades 4 to rotate relative to the housing 1 in a second direction, the first direction and the second direction being opposite to each other, thereby changing an aperture size of the light-passing hole 41 to achieve aperture adjustment. Moreover, since the guide members 6 are disposed between the housing 1 and the rotor assembly 3 and are in point or surface contact with the rotor assembly 3, during rotation of the rotor assembly 3, the guide members 6 can laterally support the rotor assembly 3 and guide the rotation of the rotor assembly 3. This ensures coaxiality between the rotor assembly 3 and the stator 2 and suppresses eccentricity of the blades 4 relative to an optical axis of the variable aperture device, thereby ensuring imaging quality.

In some embodiments of the present disclosure, the stator 2 and the rotor assembly 3 are coaxially disposed. One of the first direction and the second direction is a clockwise direction, and the other of the first direction and the second direction is a counter-clockwise direction. For example, when the blades 4 rotate in the clockwise direction, the aperture size of the light-passing hole 41 increases; and when the blades 4 rotate in the counter-clockwise direction, the aperture size of the light-passing hole 41 decreases.

In some embodiments of the present disclosure, the elastic member 5 is disposed between the rotor assembly 3 and the housing 1. When the rotor assembly 3 rotates in the first direction under the action of the drive force, the elastic member 5 is compressed. When the drive force is removed, the elastic member 5 may provide a tangential restoration force balancing the driving force, and the rotor assembly 3 rotates in the second direction under the action of the restoration force.

It should be noted that the restoration force provided by the elastic member 5 is far greater than frictional forces between the guide member 6 and the rotor assembly 3, and between the blades 4 and the housing 1, so that the closed-loop control of the variable aperture device is dominated by the elastic member 5, with the guide member 6 serving a supplementary role. Moreover, in comparison with traditional designs relying on friction (such as those using balls or rollers), the elastic member 5 exhibits less variation during mass production and thus achieves better consistency. Furthermore, the elastic member 5 is not susceptible to the risk of change in elastic coefficient during long-term operation or when subjected to an external force (such as from dropping), thereby exhibiting higher reliability.

In some embodiments of the present disclosure, the guide member 6 may be a ball, a roller, an arc-shaped member, or the like, allowing the guide member 6 to be in point or surface contact with the rotor assembly 3.

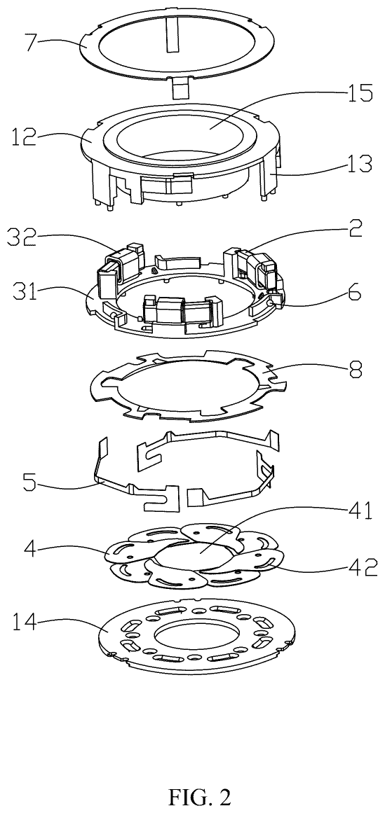

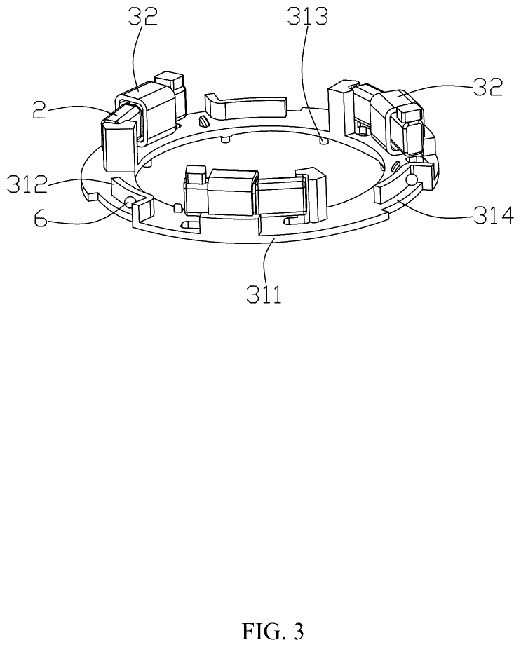

Referring to FIG. 1, FIG. 2, and FIG. 3, in some embodiments, the rotor assembly 3 includes a turntable 31 rotationally disposed within the housing 1 and connected to the blades 4. The guide member 6 is positioned between an outer periphery of the turntable 31 and an inner periphery of the housing 1, so that the guide member 6 provides lateral support to the turntable 31. The guide member 6 is in point or surface contact with the turntable 31, so that the guide member 6 provides guidance for the rotation of the turntable 31. When rotating, the turntable 31 drives the blades 4 to rotate. The blades 4 are all distributed on and connected to the turntable 31, which enables synchronous rotation of the blades 4.

Referring to FIG. 1, FIG. 2, and FIG. 3, in some embodiments, the turntable 31 is provided with at least three abutment portions 313 spaced apart in a circumferential direction of the turntable 31. An arc-shaped slide slot 42 is disposed in each of the blades 4. The abutting portions 313 are slidably assembled in the slide slots 42 in one-to-one correspondence. When the turntable 31 rotates in the first direction, each respective abutment portion 313 slides toward one end of a respective slide slot 42 and abuts the blade 4 to drive. When the turntable 31 rotates in the second direction, the respective abutment portion 313 slides toward the other end of the respective sliding slot 42 and abuts against the blade 4 to drive its rotation. In this way, the diameter of the light-passing hole 41 is changed.

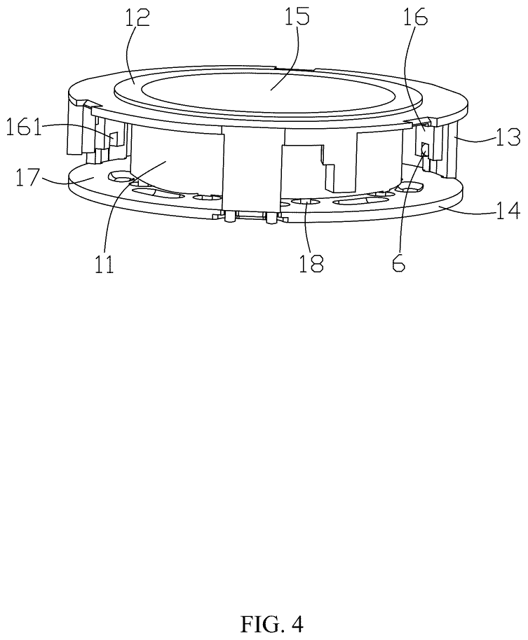

Referring to FIG. 2, FIG. 3, and FIG. 4, in some embodiments, the housing 1 includes a base plate 12, a first side plate 13 extending from the base plate 12 along an axial direction of the light-passing hole 41, and a top plate 14 secured to an end of the first side plate 13 away from the base plate 12. The base plate 12, the first side plate 13, and the top plate 14 define an accommodation chamber 11. The turntable 31 includes an annular base frame 311 rotatably connected to the first side plate 13, and a guide portion 312 extending from the base frame 311 along the axial direction of the light-passing hole 41. The first side plate 13 is spaced apart from and faces the guide portion 312, and the guide member 6 is disposed on an inner side of the housing 1 and is in point or surface contact with the guide portion 312. Compared with a configuration where an outer side of the base frame 311 is in contact with the guide member 6, configuring the guide portion 312 to be in point or surface contact with the guide member 6 can increase the contact area, which is conducive to enhancing a frictional force and a lateral support effect. Moreover, the thickness of the base frame 311 may be freely designed, which facilitates the reduction of the thickness of the base frame 311, thereby reducing the difficulty in driving the turntable 31 to rotate.

According to actual needs, the guide portion 312 may be arc-shaped to facilitate the establishment of point or surface contact between the guide member 6 and the rotor assembly 3. A slide track 314 is enclosed and formed by the guide portion 312, the base frame 311 and the housing 1, and the guide member 6 is slidably assembled in the sliding track 314.

Referring to FIG. 3 and FIG. 4, in some embodiments, the first side plate 13 is provided with a positioning groove 161 on a side of the first side plate 13 facing the guide portion 312, and the guide member 6 is assembled in the positioning groove 161. In this way, it is ensured that the guide portion 312 is spaced apart and faces the housing 1 while the base frame 311 is rotatably connected to the housing 1, thereby reducing the fitting difficulty of the housing 1, the guide member 6, and the turntable 31. Moreover, the guide member 6 may be rollable in the positioning groove 161, which is conducive to reducing a frictional force between the turntable 31 and the housing 1.

Referring to FIG. 3 and FIG. 4, in some embodiments, the first side plate 13 is provided with a positioning portion 16 on the side of the first side plate 13 facing the guide portion 312, and the positioning portion 16 protrudes toward the guide portion 312 and is spaced apart from the guide portion 312. The positioning groove 161 is disposed in the positioning portion 16 and extends through an end of the positioning portion 16 adjacent to the base frame 311, and the guide member 6 is in point contact with the base frame 311. In this way, multi-point support for the turntable 31 is achieved using the guide member 6, so that the rotational stability of the turntable 31 is enhanced.

It should be noted that the number of the guide members 6 is set according to actual needs, for example, two, three, four, or the like. A plurality of groups of guide members 6 may be provided, and are spaced apart circumferentially. A plurality of guide members 6 are provided in each group, and are continuously distributed.

Referring to FIG. 1 and FIG. 4, in some embodiments, the housing 1 further includes a second side plate 15 connected to the base plate 12 and the top plate 14. The first side plate 13 and the second side plate 15 are spaced apart and oppositely disposed, and the base plate 12, the first side plate 13, the top plate 14, and the second side plate 15 define a sealed accommodation chamber 11, thereby improving sealing performance.

Referring to FIG. 2 and FIG. 4, in some embodiments, a plurality of pivot shafts 18 are arranged on a side of the top plate 14 facing the base frame 311 and are spaced apart in a circumferential direction of the top plate 14. The plurality of blades 4 are rotatably connected to the plurality of pivot shafts 18 in one-to-one correspondence, so that the blades 4 are rotatable relative to the housing 1.

Referring to FIG. 1, FIG. 2, and FIG. 3, in some embodiments, the rotor assembly 3 further includes a rotor unit 32 secured to the turntable 31 and sleeved to an outer side of the stator 2. A plurality of rotor units 32, a plurality of stators 2 and a plurality of elastic members 5 are provided. The plurality of rotor units 32 are disposed in one-to-one correspondence with the plurality of stators 2, and the plurality of elastic members 5 are connected to the plurality of rotor units 32 in one-to-one correspondence. In this way, the rotor assembly 3 is lighter in weight, enabling faster start-stop response when the rotor units 32 are energized. Moreover, the rotor assembly 3 is annular in its entirety, with the blades 4 circumferentially spaced apart thereon. When the aperture size is adjusted, the blades 4 follow the rotation of the rotor assembly 3 to rapidly reach a designated position without jitter, achieving zero delay and precise aperture values to enhance user experience. Each of the rotor units 32 is connected to one elastic member 5, and the restoration force provided by the elastic member 5 balances the drive force, thereby ensuring minimal jitter when the rotor unit 32 reaches the designated position. This reduces the operating time and frequency in closed-loop control intervention, saving power consumption.

It should be noted that the number of rotor units 32, the number of elastic members 5, and the number of the stators 2 may all be set according to actual needs, for example, two, three, four, or the like. For example, three stators 2 are provided. The three stators 2 are equidistantly and circumferentially secured to the housing 1. Three rotor units 32 are sleeved to outer sides of the three stators 2 in one-to-one correspondence. Three elastic members 5 are connected to the three rotor units 32 in one-to-one correspondence, and an end of each of the elastic members 5 away from the rotor unit 32 is secured to the housing 1.

In some embodiments, the rotor unit 32 may be a coil, the elastic member 5 may be a leaf spring, and the stator 2 may be a magnetic steel.

Referring to FIG. 1 and FIG. 4, in some embodiments, a length direction of each of the elastic members 5 extends along a circumferential direction of the variable aperture device, i.e., the elastic member 5 is arc-shaped. Two ends of each of the elastic members 5 along the length direction are respectively connected to the housing 1 and one rotor unit 32. In this way, the elastic member 5 provides a tangential restoration force balancing the drive force.

Referring to FIG. 1 and FIG. 4, in some embodiments, an avoidance notch 17 is arranged in the housing 1, and the elastic member 5 is at least partially disposed opposite to the avoidance notch 17. In this way, when the elastic member 5 is bent under force, the avoidance notch 17 may provide a space to accommodate the elastic member 5, so that the elastic member 5 is prevented from abutting against the housing 1.

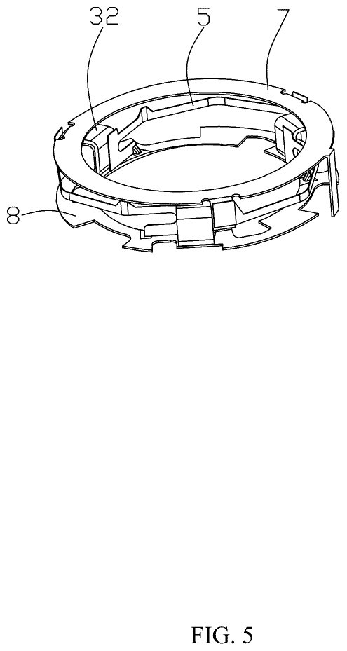

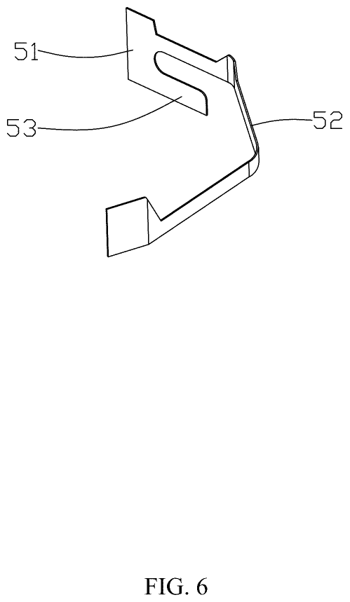

Referring to FIG. 2, FIG. 5, and FIG. 6, in some embodiments, the variable aperture device further includes a first conductive member 7 secured to the housing 1, and a second conductive member 8 secured to the rotor assembly 3 and spaced apart from the first conductive member 7. The elastic member 5 is electrically connected to the first conductive member 7, the second conductive member 8, and the rotor assembly 3 separately. In this way, the rotor assembly 3 achieves electrical conduction through the first conductive member 7, the second conductive member 8, and the elastic member 5, which provides a simple structure and facilitates circuit layout within the accommodation chamber 11. Moreover, the elastic member 5 may serve as a circuit conduction component for the rotor unit 32, thereby serving a dual purpose.

Referring to FIG. 5, in some embodiments, the first conductive member 7 and the second conductive member 8 are both annular. The plurality of elastic members 5 may be connected to different positions on the first conductive member 7 and the second conductive member 8, which facilitates the installation of the elastic members 5.

Referring to FIG. 5 and FIG. 6, in some embodiments, the elastic member 5 includes a connection portion 51 secured to the rotor assembly 3, a first conductive portion 52 having two ends respectively connected to the connection portion 51 and the first conductive member 7, and a second conductive portion 53 having two ends respectively connected to the connection portion 51 and the second conductive member 8. The first conductive portion 52 and the second conductive portion 53 are spaced apart from each other. In this way, the first conductive member 7, the first conductive portion 52, the rotor unit 32, the second conductive member 8, and the second conductive portion 53 constitute a power supply circuit with a simple structure.

Described above are merely exemplary embodiments of the present disclosure. It should be noted that persons of ordinary skill in the art would make various improvements without departing from the inventive concept of the present disclosure, and such improvements shall fall within the protection scope of the present disclosure.

1. A variable aperture device, comprising:
a housing, having an accommodation chamber;
a stator, secured to the housing and positioned within the accommodation chamber;
a rotor assembly, rotatably connected to the housing and positioned within the accommodation chamber;
at least three blades, rotatably connected to the housing and connected to the rotor assembly, wherein the rotor assembly and the stator are mutually inductive to generate a drive force for driving the rotor assembly to rotate, and the at least three blades are configured to be driven by the rotor assembly to rotate relative to the housing, so as to form a light-passing hole with a variable aperture size;
an elastic member, having two ends connected to the housing and the rotor assembly, respectively; and
a plurality of guide members, disposed between the housing and the rotor assembly and spaced apart in a circumferential direction of the variable aperture device, wherein the plurality of guide members are in point contact or surface contact with the rotor assembly.

2. The variable aperture device according to claim 1, wherein the rotor assembly includes a turntable rotatably disposed within the housing and connected to the at least three blades, and wherein the plurality of guide members are positioned between an outer periphery of the turntable and an inner periphery of the housing and are in point contact or surface contact with the turntable.

3. The variable aperture device according to claim 2, wherein the housing includes:
a bottom plate;
a first side plate, extending from the bottom plate along an axial direction of the light-passing hole; and
a top plate, secured to an end of the first side plate away from the bottom plate;
wherein the bottom plate, the first side plate, and the top plate define the accommodation chamber;
wherein the turntable includes:
an annular base frame, rotatably connected to the first side plate; and
a guide portion, extending from the base frame along the axial direction of the light-passing hole, wherein the first side plate and the guide portion are spaced apart from and face each other, and a respective guide member is disposed on an inner side of the first side plate and is in point contact or surface contact with the guide portion.

4. The variable aperture device according to claim 3, wherein the first side plate is provided with a positioning groove on a side of the first side plate facing the guide portion, and the respective guide member is assembled in the positioning groove.

5. The variable aperture device according to claim 4, wherein the first side plate is provided with a positioning portion on the side of the first side plate facing the guide portion, wherein the positioning portion protrudes toward the guide portion and is spaced apart from the guide portion; and
the positioning groove is disposed in the positioning portion, and extends through an end of the positioning portion adjacent to the base frame.

6. The variable aperture device according to claim 2, wherein the rotor assembly further includes:
a rotor unit, secured to the turntable and sleeved on an outer side of the stator;
wherein a plurality of rotor units, a plurality of rotors and a plurality of elastic members are provided;
wherein the plurality of rotor units are spaced apart in the circumferential direction of the variable aperture device, and are disposed in one-to-one correspondence with the plurality of stators, and the plurality of elastic members are connected to the plurality of rotor units in one-to-one correspondence.

7. The variable aperture device according to claim 6, wherein a length direction of each respective elastic member of the plurality of elastic members extends in the circumferential direction of the variable aperture device, and two ends of the respective elastic member in the length direction are respectively connected to the housing and a respective rotor unit of the plurality of rotor units.

8. The variable aperture device according to claim 1, further comprising:
a first conductive member, secured to the housing; and
a second conductive member, secured to the rotor assembly and spaced apart from the first conductive member;
wherein the elastic member is electrically connected to the first conductive member, the second conductive member, and the rotor assembly separately.

9. The variable aperture device according to claim 8, wherein the elastic member includes:
a connection portion, secured to the rotor assembly;
a first conductive portion, having two ends connected to the connection portion and the first conductive member, respectively; and
a second conductive portion, having two ends connected to the connection portion and the second conductive member, respectively;
wherein the first conductive portion and the second conductive portion are spaced apart from each other.

10. The variable aperture device according to claim 1, wherein the guide member is a ball, a roller or an arc-shaped member.

11. The variable aperture device according to claim 3, wherein the variable aperture device further comprises:
a plurality of pivot shafts, arranged on a side of the top plate facing the base frame and are spaced apart in a circumferential direction of the top plate;
wherein the plurality of blades are rotatably connected to the plurality of pivot shafts in one-to-one correspondence to allow the blades to rotate relative to the housing.

12. A camera module, comprising the variable aperture device as claimed in claim 1.
